(19) United States
(12) Patent Application Publication
(10) Pub. No.: US 2017/0083667 A1
(43) Pub. Date: Mar. 23, 2017

(54) EMERGENCY SERVICE PROVIDER MONITORING AND REHABILITATION METHODS AND DEVICES

(71) Applicant: Athena GTX, Inc., Des Moins, IA (US)

(72) Inventors: Greg Darrah, West Des Moins, IA (US); Ellen Miller, West Des Moines, IA (US); John Elson, San Antonio, TX (US); Freeman Jones, Nashville, TN (US)

(21) Appl. No.: 15/255,825

(22) Filed: Sep. 2, 2016

Related U.S. Application Data
(60) Provisional application No. 62/220,051, filed on Sep. 17, 2015.

(51) Int. Cl. G06F 19/00

(52) U.S. Cl. CPC G06F 19/322; G06F 19/3406

(57) ABSTRACT

Systems and methods for simultaneously tracking physical conditions of multiple people during an event are disclosed. The system comprises at least one vital sign data collection device, a central processing unit compiling the collected vital sign data, and software executing on the central processing unit. Wherein the software analyzes the data for each person, determines if the vital signs of each person are above a threshold, recommends rehabilitation for each person having vital signs above the threshold, determines when each person undergoing rehabilitation has been rehabilitated, recommends returning rehabilitated persons to the field, compiles an analysis of the multiple people tracked during the event, and outputs a summary of the vital sign data for the event.

### REFERENCE TO RELATED APPLICATIONS

The present application claims priority to Provisional U.S. Application No. 62/220,051, filed Sep. 17, 2015, entitled “EMERGENCY SERVICE PROVIDER MONITORING AND REHABILITATION METHODS AND DEVICES,” and is incorporated herein in its entirety.

### BACKGROUND

1. Field of the Invention

The invention is directed to tools and methods to facilitate the acquisition and storage of vital medical, operations, and logistics data regarding rehabilitation of deployed personnel.

2. Background of the Invention

According to the standards and recommendations implemented by the National Fire Protection Association (NFPA), contained within document NFPA 1584, several advancements have been made regarding the rehabilitation of active emergency personnel on the scene of an incident. With these advancements comes the need for medical and logistical data from the scene and also summarized after the scene. Rehabilitation aspects of NFPA 1538 include: Relief from climate conditions; rest and recovery; active and/or passive cooling or warming as needed for incident types and climate conditions; rehydration; calorie and electrolyte replacement, as appropriate, for longer duration incidents; medical monitoring; member accountability; and release from rehab to return to duty.

NFPA 1584 calls for a minimum standard of care available at incident scenes, and resources for transport if needed. Personnel performing the medical monitoring should evaluate all working members for symptoms suggestive of a health or safety concern at two points: first when they enter the rehab process and second prior to release, to ensure there are no obvious indications that the person is incapable of performing full-duty activities.

The standard also specifies that personnel performing medical monitoring should assess for: Chest pain, dizziness, shortness of breath, weakness, nausea or headache; general complaints such as cramps or aches and pains; symptoms of heat or cold-related stress; changes in gait, speech or behavior; alertness and orientation to person, place and time; and abnormal vital signs.

In order to determine if emergency personnel are in need of rehabilitation and have become rehabilitated, each person's vitals must be evaluated and monitored.

### SUMMARY OF THE INVENTION

The present invention overcomes the problems and disadvantages associated with current fire/rescue data management strategies and the review of the operational standards per department, while also providing new tools for medical data acquisition and methods of employing organized analytics both on-scene and post-incident.

One embodiment of the invention is directed towards progressive rescue services that provide increased capabilities during emergency incident rehabilitation operations.

Another embodiment of the invention is directed to systems for simultaneously tracking physical conditions of multiple people during an event. The system comprises at least one vital sign data collection device, a central processing unit compiling the collected vital sign data, and software executing on the central processing unit. Preferably the software analyzes the data for each person, determines if the vital signs of each person are above a threshold, recommends rehabilitation for each person having vital signs above the threshold, determines when each person undergoing rehabilitation has been rehabilitated, recommends returning rehabilitated persons to the field, compiles an analysis of the multiple people tracked during the event, and outputs a summary of the vital sign data for the event. Preferably, the people are emergency service providers and the event is an emergency.

In a preferred embodiment, each person is coupled to a personal vital sign data collection device. Preferably, each personal vital sign data collection device is worn on each person's body and monitors for at least one of current physical condition, environmental conditions around the person, and the time the person has been in at the event. Preferably, each personal vital sign data collection device communicates wirelessly with the central processing unit. Each personal vital sign data collection device preferably tracks the location of each person. Preferably, each personal vital sign data collection device is adapted to produce at least one of an audible, visual, and tactile alarm if physical or environmental conditions reach a predetermined threshold or if the person's time in at the event has expired.

In a preferred embodiment, the central processing unit tracks data of each person and a brigade as a whole over multiple deployments. Preferably, the system further comprises a medical service provider interface. Preferably, the medical service provider interface provides medical information about a person in route to the medical service provider.

Another embodiment of the invention is directed to a method of simultaneously tracking physical conditions of multiple people during an event. The method comprises the steps of monitoring each person with a vital sign data collection device, compiling the collected vital sign data for each person at a central processing unit, analyzing the data for each person, determining if the vital signs of each person are above a threshold, recommending rehabilitation for each person having vital signs above the threshold, determining when each person undergoing rehabilitation has been rehabilitated, recommending returning rehabilitated persons to the field, compiling an analysis of the multiple people tracked during the event, and outputting a summary of the vital sign data for the event.

Preferably, the people are emergency service providers and the event is an emergency. In a preferred embodiment the method further comprises coupling each person to a personal vital sign data collection device. Preferably, each personal vital sign data collection device is worn on each person's body and monitors for at least one of current physical condition, environmental conditions around the person, and the time the person has been in at the event. Preferably, each personal vital sign data collection device communicates wirelessly with the central processing unit. The method preferably further comprises tracking the location of each person with each personal vital sign data collection device. Preferably, each personal vital sign data collection device is adapted to produce at least one of an audible, visual, and tactile alarm if physical or environmental conditions reach a predetermined threshold or if the person's time in at the event has expired.

In a preferred embodiment the method further tracks data of each person and a brigade as a whole over multiple deployments. Preferably, the method further comprises interfacing with a medical service provider and providing medical information about a person in route to the medical service provider.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 illustrates an example system embodiment.

FIG. 2 demonstrates the autonomous medical data acquisition of the system and the resulting data transmission and logging of on-scene information for responders, patients, as well as the final medical treatment facility if needed.

FIG. 3 depicts an embodiment of the topography of a medical data tracking system.

FIG. 4 depicts an embodiment of the topography of a medical data tracking system using cellular communication protocols.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

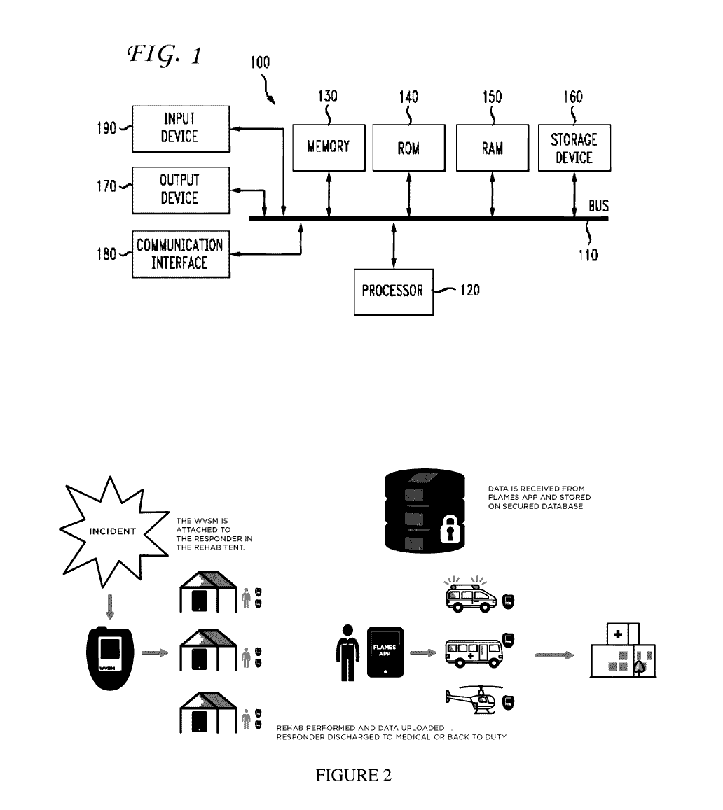

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, a handheld scanning device, or a wireless devices, including wireless Personal Digital Assistants (“PDAs”) (e.g., Microsoft's Windows, Research in Motion's Blackberry™, an Android™ device, Apple's iPhone™), tablet devices (e.g., Amazon's Kindle™, Apple's iPad™), wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention also include computer-readable media (or software) for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above may also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the preferred embodiment, the computer-readable media is hosted on a central computing device and delivered to remote computing devices via a network connection (as described herein). The computer-readable media is preferably a software as a service (SaaS) application with the remote computing devices accessing the SaaS via a web browser, downloaded application, or another interface. However, in other embodiments, at least a portion of the computing is completed on the remote computing devices.

In the preferred embodiment, a user utilizes an Internet connection in order to access a website on a host computer or to log into a mobile application. The different programs may be physically hosted together or separately. The web site may, for example, be maintained and hosted by a manufacturer, a supplier, or an Internet Service Provider. The website, when accessed, may request a user to log into the site by entering a username and password. Although, non-registered and non-logged in users may be able to browse the website. In the preferred embodiment, users will log in using a User Name and Password. However, in certain embodiments, additional information can be required, for example store number or company identification. The User Name and Password can be an email address or combination of letters, numbers, and/or symbols. Preferably, each User Name is unique. Based on user identification, access to the system can be determined. Furthermore, based on user identification, a user's preferences, accessible databases, and other resources the user has access to, is uploaded.

The system is preferably completely API (application programming interface) driven. Preferably, all access to the central processor, both internally and externally, is through the use of APIs. APIs can be opened to external web sites to enable creation of offers, redemption of offers, and other access to the central processor. Therefore, external systems can, if allowed by the system through valid authorization tokens, use some or all elements of the system to create new applications, enhancements or implementations without having to develop their own processes and systems which replicate functions and actions capable of being performed by the system.

The system is easily configurable for white labeling. As such, the system can be tailored to and/or branded for one or more specific purposes or companies and each such instance can run simultaneously. Each instance of the system may be branded for the third party and the third party could manage its own environment using the internal system controls (DERF/backend interface). Preferably in all such instances, each new instance's environment's subscribers and merchants would be segregated from the original instance (and all other instances) of the system.

A problem in the art capable of being solved by the embodiments of the present invention is the current lack of comprehensive medical assessment and data management equipment for the emergency incident scenarios commonly encountered by rescuers. Emergency incidents may include, for example, fires, tornados, earthquakes, terrorist attacks, chemical spills, building collapses, hurricanes, floods, avalanches, vehicle accidents, riots, missing person searches, medical epidemics, or other manmade or naturally occurring disasters. It has been surprisingly discovered that the autonomous tracking and saving of pertinent medical data, as well as on-scene logistics and rehabilitation data on the site of a fire or other emergency scene, will improve organizational functionality and personnel safety simultaneously. Preferably, the system maintains and updates a database consisting of multiple rehabilitation statistics, including, but not limited to: amount of responders in rehab area, time in, time out, average time in rehab area.

An active emergency response department on the scene of an incident requiring monitored rehabilitation of deployed personnel may benefit from the instant invention before, during, and after the incident itself. The system's features include incident geolocation, on-site weather information, organized departmental and personnel management, as well as detailed post-incident analytics. The system enables those responsible for rehabilitation operations to accurately track the quantity, quality, and duration of rehab visits, vital signs, and vital signs trending for each responder, for the entirety of each incident. Vital signs may include, for example, pulse rate, respiration rate, perspiration, hydration levels, temperature, blood pressure, balance, ambulation, speech slurring, or other physical attributes of the person. Preferably, the system tracks multiple responders simultaneously. With this data, not only will the immediate effectiveness of rehabilitation flourish, but the organizational quality of operations for each responsible entity can be evaluated in detail, with strengths and weaknesses further delineated. For progressive public service organizations, this information is crucial in providing the highest standard of care for those directly affected by emergency incidents. While the invention is described in terms of emergency responders, the system can be used in other disciplines, for example, for military purposes, for athletes, for workers in adverse or extreme conditions, and for tracking medical patients. Likewise, the system can also be useful in tracking animals' conditions.

The invention allows for easy viewing of vital sign data and easy statistical analysis of an incident. Preferably a device wirelessly transmits a patient's vital signs to a computer based application that will display all of the vitals taken in a specified period as a trend. Historical patient data may also be available as a trend. Furthermore, both individual and department wide statistics on rehab usage and vital signs may be collected and analyzed.

FIG. 2 depicts an embodiment of a system of the invention. Preferably, each emergency responder is outfitted with a tracking device. The tracking device may be wearable (e.g. a vest, bracelet, watch, electrodes placed on the body, head peace, integrated into a helmet, arm band, integrated into clothing, or otherwise able to be worn by the emergency responder), implantable, hand held, or integrated into a personal electronic device (e.g. a cellular phone, a tablet, or a radio). The tracking device may track the location of the responder (e.g. using GPS or another location tracking method), the responder's current physical condition, environmental conditions around the responder, and the time the responder has been in the field. The tracking device may be able to produce an audible, visual, and/or tactile alarm if certain physical or environmental conditions reach a predetermined threshold or if the responder's time in the field has expired.

Preferably, the tracking device communicates wirelessly with a central processing unit. Preferably, the central processing unit contains a secure database that meets or exceeds HIPPA regulations. The central processing unit may be co-located at the scene of the emergency or may be located off site. The tracking device may upload data to the central processing unit continuously, at pre-determined intervals, or randomly. Preferably, the tracking device has internal storage and is able to maintain data, for example, if the tracking device is unable to communicate with the central processing unit for a period of time. In another embodiment, the tracking device may be directly coupled to the central processing unit, or an extension thereof, to upload the data.

In another embodiment, one or more stationary vital sign monitoring devices may be located at the rehabilitation center and each responder is connected to the vital sign monitoring device upon entering the rehabilitation center. In another embodiment, a person at the rehabilitation center manually obtains each responder's vital signs and enters them into a computer.

Preferably, the central processing unit tracks the data received from all of the emergency responders to asses each responders current condition and the status of the brigade as a whole. Preferably, the central processing unit is able to determine if each responder needs to take a break, be rehabilitated, has been rehabilitated and is ready to return to the field, or needs medical attention. Furthermore, the central processing unit preferably tracks the data of each responder and the brigade as a whole over the course of multiple deployments. Thereby, the central processing unit may be able to provide improved recommendations over time as more statistics become available. Additionally, each responder's non-emergency vital signs may be uploaded periodically to provide a baseline for that responder, further improving the data stored by the central processing unit. The central processing unit may additional store demographic information for each responder. Furthermore, in case a responder needs medical attention, the central processing unit may be able to upload data to a medical caregiver or a hospital.

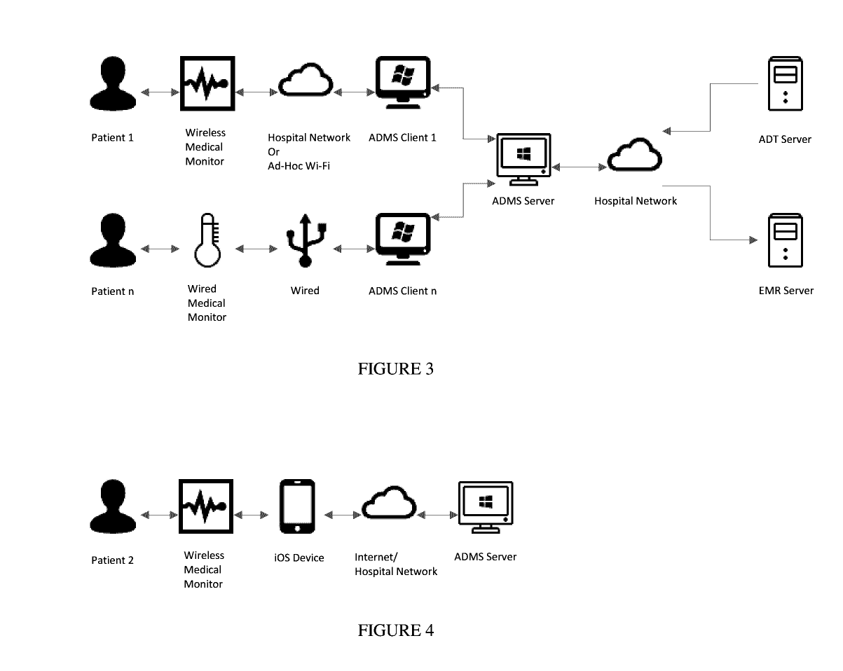

The system may be a part of a larger medical data tracking system. The medical data tracking system is preferably a group of client and server applications used to collect, store, display, and transmit patient data. For example, FIG. 3 depicts an embodiment of the topography of a medical data tracking system. As shown in FIG. 3, in the preferred embodiment, there are one or more clients and one server. Each client preferably communicates with the server via wireless or wired communication protocols. The client preferably communicates with medical monitors via Wi-Fi and USB. The client can preferably communicate with multiple medical monitors simultaneously. The client is preferably used to collect and view vitals data. The data is preferably sent to the server and clients are able to view data collected by other clients. Clients may also be used to review historical data previously collected.

In another embodiment, shown in FIG. 4, a client may be in communication with a cellular phone, tablet, or other smart device and the device may communicate with the server. For example, a cell phone application can collect and display data from multiple Wi-Fi enabled medical monitors simultaneously and can transmit this data to the server via Wi-Fi or 4G communication protocols. Such connectivity may be useful for collecting data from the field such as at the point of injury or from an ambulance or life flight. Preferably, the data can be seen live by a client at the receiving facility.

The server preferably acts as a central repository for all data collected by the clients. The server preferably also acts as an interface with a hospital network. Reports can be sent in response to a query, at predetermined intervals, manually via a button press, or when a run is started or finished. For example, the server ma interface to patient demographics providers and electronic medical records systems. The server may receive inbound ADT (Admit, Discharge, and Transfer) messages to fill patient rosters and report patient vital signs. Preferably, the system is designed in compliance with the requirements of HIPPA regulations. Preferably, the system uses a plugin system where each customer has a custom plugin. The plugin can be a USB device, an RF device, a key card, a magnetic strip, an NFC device, a key code, or another unique identifier.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A system for simultaneously tracking physical conditions of multiple people during an event, comprising:
at least one vital sign data collection device;
a central processing unit compiling the collected vital sign data for each person;
software executing on the central processing unit, wherein the software:
analyzes the data for each person;
determines if the vital signs of each person are above a threshold;
recommends rehabilitation for each person having vital signs above the threshold;
determines when each person undergoing rehabilitation has been rehabilitated;
recommends returning rehabilitated persons to the field;
compiles an analysis of the multiple people tracked during the event; and
outputs a summary of the vital sign data for the event.

2. The system of claim 1, wherein the people are emergency service providers and the event is an emergency.

3. The system of claim 1, wherein each person is coupled to a personal vital sign data collection device.

4. The system of claim 3, wherein each personal vital sign data collection device is worn on each person's body and monitors for at least one of current physical condition, environmental conditions around the person, and the time the person has been in at the event.

5. The system of claim 3, wherein each personal vital sign data collection device communicates wirelessly with the central processing unit.

6. The system of claim 3, wherein each personal vital sign data collection device tracks the location of each person.

7. The system of claim 3, wherein each personal vital sign data collection device is adapted to produce at least one of an audible, visual, and tactile alarm if physical or environmental conditions reach a predetermined threshold or if the person's time in at the event has expired.

8. The system of claim 1, wherein the central processing unit tracks data of each person and a brigade as a whole over multiple deployments.

9. The system of claim 1, further comprising a medical service provider interface.

10. The system of claim 9, wherein the medical service provider interface provides medical information about a person in route to the medical service provider.

11. A method of simultaneously tracking physical conditions of multiple people during an event, comprising:
monitoring each person with a vital sign data collection device;
compiling the collected vital sign data for each person at a central processing unit;
analyzing the data for each person;
determining if the vital signs of each person are above a threshold;
recommending rehabilitation for each person having vital signs above the threshold;
determining when each person undergoing rehabilitation has been rehabilitated;
recommending returning rehabilitated persons to the field;
compiling an analysis of the multiple people tracked during the event; and
outputting a summary of the vital sign data for the event.

12. The method of claim 11, wherein the people are emergency service providers and the event is an emergency.

13. The method of claim 11, further comprising coupling each person to a personal vital sign data collection device.

14. The method of claim 13, wherein each personal vital sign data collection device is worn on each person's body and monitors for at least one of current physical condition, environmental conditions around the person, and the time the person has been in at the event.

15. The method of claim 13, wherein each personal vital sign data collection device communicates wirelessly with the central processing unit.

16. The method of claim 13, further comprising tracking the location of each person with each personal vital sign data collection device.

17. The method of claim 13, wherein each personal vital sign data collection device is adapted to produce at least one of an audible, visual, and tactile alarm if physical or environmental conditions reach a predetermined threshold or if the person's time in at the event has expired.

18. The method of claim 11, further comprising tracking data of each person and a brigade as a whole over multiple deployments.

19. The method of claim 11, further comprising interfacing with a medical service provider.

20. The method of claim 19, further comprising providing medical information about a person in route to the medical service provider.
